(19) United States
(12) Patent Application Publication
(10) Pub. No.: US 2005/0047424 A1
(43) Pub. Date: Mar. 3, 2005

(54) Method and system for managing bandwidth use in broadcast communications

(76) Inventors: Norman Hutchinson, Richmond (CA); Terry Coatta, Richmond (CA); James Wright, Vancouver (CA)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/893,273

(22) Filed: Jul. 19, 2004

Related U.S. Application Data
(60) Provisional application No. 60/488,606, filed on Jul. 21, 2003.

(51) Int. Cl. H04B 3/20

(52) U.S. Cl. 370/401; 370/465

(57) ABSTRACT

Methods and systems in accordance with the present invention manage bandwidth use in broadcast communications. More particularly, methods and systems in accordance with the present invention may be used to achieve reliable broadcast communications in a wireless network. They may provide network communication software that controls when data packets are transmitted via a wireless physical layer interconnect, thus increasing the overall reliability and throughput that are achieved when using broadcast communications. Methods and systems in accordance with the present invention improve throughput in various types of networks, e.g., Ethernet networks in which the network switches have a limited broadcast capacity, including wired networks.

### RELATED APPLICATIONS

This application is related to, and claims priority to the following U.S. Provisional Patent Application which is hereby incorporated by reference herein:
U.S. Provisional Patent Application Ser. No. 60/488,606, filed on Jul. 21, 2003, entitled “System and Method for Enhancing Collaboration using Computers and Networking.”

This application is also related to the following U.S. patent applications which are hereby incorporated by reference herein:
U.S. Provisional Patent Application Ser. No. 60/427,965, filed on Nov. 21, 2002, entitled “System and Method for Enhancing Collaboration using Computers and Networking.”
U.S. Provisional Patent Application Ser. No. 60/435,348, filed on Dec. 23, 2002, entitled “Method and System for Synchronizing Data in Ad Hoc Networking Environments.”
U.S. patent application Ser. No. 10/715,381, filed on Nov. 19, 2003, entitled “Method and System for Enhancing Collaboration Using Computers and Networking.”
U.S. patent application Ser. No. 10,715,382, filed on Nov. 19, 2003, entitled “Method and Systems for Synchronous and Asynchronous Note Timing in a System for Enhancing Collaboration Using Computers and Networking.”
U.S. patent application Ser. No. 10/715,375, filed on Nov. 19, 2003, entitled “Method and System for Sending Questions, Answers and Files Synchronously and Asynchronously in a System for Enhancing Collaboration Using Computers and Networking.”
U.S. patent application Ser. No. 10/715,508, filed on Nov. 19, 2003, entitled “Method and System for Synchronizing Data in Peer to Peer Networking Environments.”

### BACKGROUND

1. Field of the Invention

Methods and systems in accordance with the present invention generally relate to data processing systems. In particular, methods and systems in accordance with the present invention generally relate to managing bandwidth use in network communications.

2. Background

Conventional network systems (which may be implemented via hardware, software, or a combination of the two) are frequently designed to detect when two hosts attempt to transmit onto the network at the same time. When this occurs, the two transmissions are said to collide, and the usual result is that both transmissions are corrupted such that no useful information can be obtained at the receiver. Because of this potential for packets to collide, networking hardware and software may implement a system that governs when packets are permitted to be transmitted on the network. Such a system is referred to as a Media Access Control (“MAC”) protocol.

There are a number of different MAC protocols that govern when a host is allowed to transmit a packet onto a network. One such system, called Collision Detection/Collision Avoidance (“CD/CA”), is used in wireless networks such as 802.11b. This system both detects collisions when they occur and attempts to minimize the occurrence of collisions by controlling when hosts are allowed to transmit a packet onto the network.

In general, networking systems support a special receiver address called the broadcast address. When a host transmits to this address, it is typically received at all hosts within the network or within a particular segment of the network. A segment of a network is a collection of machines that have been organized as a group. For example, the hosts attached to a particular 802.11b access point typically form one segment.

In some network systems, for example 802.11b, the conventional MAC protocols are typically inadequate for packets being sent to the broadcast address. In an 802.11b wireless network, as the number of stations transmitting to the broadcast address increases, the rate of collisions increases, and the total available throughput of the network decreases. Such networking systems suffer from a degradation of reliability and throughput when multiple participating hosts attempt to broadcast information at the same time.

Multicast communications typically suffer from these same limitations, due to the manner in which multicast is implemented. For traffic that crosses the boundary between segments, the switch or router is responsible for making intelligent decisions about where multicast packets should be delivered. However, at the segment level, multicast communications are typically implemented by sending to the broadcast address. Thus, at the segment level, any problems associated with sending to the broadcast address will also affect multicast communications. While these problems are most prevalent in wireless networks, they may also be observed in typical wired networks, due to congestion problems that broadcast communications can create within switches and routers.

Networking systems generally provide some means of congestion control or ability to mediate quality of service. For example, in the IP protocol, there are a series of flags that are part of the structure of every packet that allow the packet to be assigned a priority. This priority level may cause the packet to be accorded special treatment such that it is delivered more quickly or more reliably to its destination. These conventional quality of service mechanisms modify the way in which data is transported across wide area networks. However, many of these conventional mechanisms do not address the manner in which packets are admitted to a local network segment and congestion issues that arise when many hosts on that segment try to use the network at the same time.

### SUMMARY

Methods and systems in accordance with the present invention manage the timing of the transmission of data in a network system. They provide control of transmission of data based on network information received from a network such as network condition, congestion and traffic. As a result, network data transmission may be controlled globally based on the aggregate performance of the network.

A method is provided in a data processing system for managing network communication comprising the steps of setting timing of transmission of data to one or more entities on a network and receiving network information from one or more entities on the network. The method further comprises adjusting the timing of transmission of data to the one or more entities on the network based on the received network information.

In one implementation, a method is provided in a data processing system comprising the steps of monitoring local network information on an entity on a network, and transmitting the monitored local network information to one or more remote entities on the network so that the one or more remote entities can adjust timing of transmission of data based on the transmitted local network information.

In another implementation, a data processing system is provided comprising a memory having a program that sets timing of transmission of data to one or more entities on a network, receives network information from one or more entities on the network, and adjusts the timing of transmission of data to the one or more entities on the network based on the received network information. The data processing system further comprises a processor for running the program.

In yet another implementation, a data processing system is provided comprising a memory having a program that monitors local network information on an entity on a network, and transmits the monitored local network information to one or more remote entities on the network so that the one or more remote entities can adjust timing of transmission of data based on the transmitted local network information. The data processing system further comprises a processor for running the program.

A computer-readable medium is provided containing instructions for controlling a data processing system to perform a method for managing network communication. The method comprising the steps of setting timing of transmission of data to one or more entities on a network, and receiving network information from one or more entities on the network. The method further comprises adjusting the timing of transmission of data to the one or more entities on the network based on the received network information.

In one implementation, a computer-readable medium is provided containing instructions for controlling a data processing system to perform a method. The method comprises the steps of monitoring local network information on an entity on a network, and transmitting the monitored local network information to one or more remote entities on the network so that the one or more remote entities can adjust timing of transmission of data based on the transmitted local network information.

### BRIEF DESCRIPTION OF DRAWINGS

The accompanying drawings, which are incorporated in and constitute a part of this specification, illustrate embodiments in accordance with the present invention and, together with the description, serve to explain the advantages and principles consistent with the present invention.

FIG. 1 depicts an exemplary data processing system suitable for use with methods and systems in accordance with the present invention, and having a plurality of computers communicating with each other using a communications network.

FIG. 2 depicts an exemplary media access control system in accordance with methods and systems consistent with the present invention.

FIG. 3 depicts a flowchart representing steps in an exemplary method for receiving data packets, accumulating statistics and transmitting sampling records in accordance with methods and systems consistent with the present invention.

FIG. 4 depicts an exemplary sampling record generated by a component shown in FIG. 2.

FIG. 5 depicts a flowchart illustrating steps in an exemplary method for receiving sampling records, computing a health heuristic and implementing a throttle value in accordance with methods and systems consistent with the present invention.

FIG. 6 illustrates steps in an exemplary method for computing a health heuristic in accordance with methods and systems consistent with the present invention.

### DETAILED DESCRIPTION

Methods and systems in accordance with the present invention manage bandwidth use in broadcast communications. More particularly, methods and systems in accordance with the present invention may be used to achieve reliable broadcast communications in a network. They may provide network communication software that controls when data packets are transmitted via a wireless physical layer interconnect, thus increasing the overall reliability and throughput that are achieved when using broadcast communications. Methods and systems in accordance with the present invention improve throughput in various types of networks, e.g., Ethernet networks in which the network switches have a limited broadcast capacity, including wired or wireless networks.

Methods and systems in accordance with the present invention provide a media access control protocol for communication networks that improves the overall throughput of the network as a whole. Methods and systems in accordance with the present invention counteract a reduction in the overall throughput of the network due to an increasing rate of collisions when the number of stations transmitting to the broadcast address increases. This may be achieved by regulating access to the network based on the degree of network congestion present. In one implementation, features of the control mechanism may include network access that is (1) controlled globally rather than on a per message basis and (2) controlled based on the aggregate performance of the network. For global network access control, the protocol maintains state regarding the recent activity of each station, in contrast to conventional MAC protocols which admit each message onto the network independently. Network access is controlled based on the aggregate performance of the network and may be computed based on individual performance statistics gathered from each station participating in the network.

These two features help the network to approach an optimal condition of sustaining a constant aggregate throughput regardless of the number of hosts using the network. However, in one implementation, as the number of hosts increases, the amount of bandwidth available to each is reduced, whereas the total available bandwidth is fixed and shared among all the hosts.

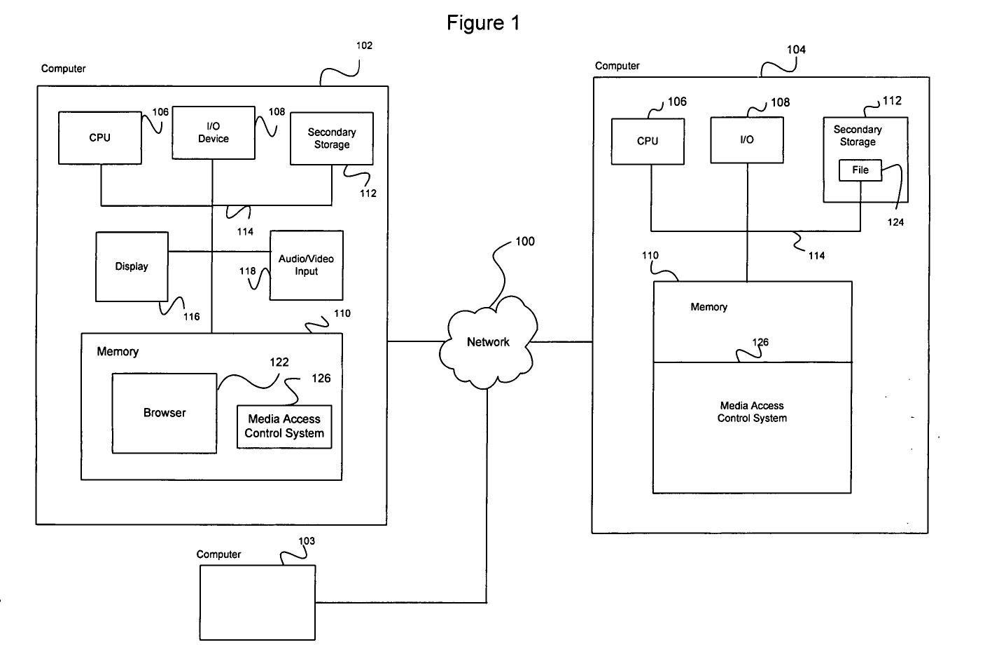

FIG. 1 depicts an exemplary data processing system suitable for use in accordance with methods and systems consistent with the present invention. FIG. 1 shows three computers 102, 103 and 104 connected to a network 100, which may be wired or wireless, and may be a LAN or WAN, and any of the computers may represent any kind of entity on the network such as any kind of data processing device, such as a general-purpose data processing device, a personal computer, a plurality of interconnected data processing devices, video game console, clustered server, a mobile computing device, a personal data organizer, router, hub, switch or a mobile communication device including mobile telephones or similar devices. The computers 102-104 may represent computers in a distributed environment, such as on a wired or wireless LAN, or the Internet. There may also be many more computers 102-104 than shown on the figure. The network 100 may be any type of network, and may be a broadcast network wherein some or all of the data packets on the network are sent to a broadcast address, or may also be other types of broadcast networks.

The computers 102-104 may have operating software operating thereon that provides basic network services. On each computer 102-104, software communicates with other computers 102-104 via a communication network 100. However, utilization of this network 100 may not be optimal. For example, in 802.11 wireless networks the media access control protocol for broadcast communications may not perform well when there is a high level of broadcast communications.

A computer 102 includes a central processing unit (“CPU”) 106, an input-output (“I/O”) unit 108 such as a mouse or keyboard, or a graphical input device such as a writing tablet, and a memory 110 such as a random access memory (“RAM”) or other dynamic storage device for storing information and instructions to be executed by the CPU. The computer 102 also includes a secondary storage device 112 such as a magnetic disk or optical disk. The computer 102 may also include a display 116 such as such as a cathode ray tube (“CRT”) or LCD monitor, and an audio/video input 118 such as a webcam and/or microphone. These components may communicate with each other via a bus 114 or other communication mechanism.

Although aspects of methods and systems consistent with the present invention are described as being stored in memory 110, one having skill in the art will appreciate that all or part of methods and systems consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may contain additional or different components. The computers 102-104 may include a human user or may include a user agent. The term “user” may refer to a human user, software, hardware or any other entity using the system. A user of a computer may include a student in a class or an instructor.

As shown, the memory 110 in the computer 102 may include a browser 122 which is an application 122 that is typically any program or group of application programs allowing convenient browsing through information or data available in distributed environments, such as the Internet or any other network including local area networks. A browser application 122 generally allows viewing, downloading of data and transmission of data between data processing devices. The browser 122 may also be other kinds of applications. Although only one browser 122 is shown, any number of browsers may be used.

The memory 110 may also include applications, including peer-to-peer applications, described in co-pending U.S. patent application Ser. Nos. 10/715,381, 10/715,382, 10/715,375 and 10/715,508 which were previously incorporated herein. Additionally, although discussed or shown on the computer 102 in the memory 110, these components may reside elsewhere, such as in the secondary storage 112, or on another computer, such as another computer. Furthermore, these components may be hardware or software whereas embodiments in accordance with the present invention are not limited to any specific combination of hardware and/or software. The memory 110 also includes a media access control system 126 described below.

FIG. 1 also depicts a computer 104 that includes a CPU 106, an I/O unit 108, a memory 110, and a secondary storage device 112 having a file 124 . These components may communicate with each other via a bus 114. The memory 110 may store a media access control system 126 which manages the functions of the computer 104 with respect to network processing and may include additional components described below. The file 124 may also reside elsewhere, such as in memory 110. The computer 104 may also have many of the components mentioned in conjunction with the computer 102. There may be many computers 104 working in conjunction with one another. The system 126 may be implemented in any way, in software or hardware or a combination thereof, and may be distributed among many computers. It may be represented by any number of components, processes, threads, etc.

The computers 102-104 may communicate directly or over networks, and may communicate via wired and/or wireless connections, including peer-to-peer wireless networks, or any other method of communication. Communication may be done through any communication protocol, including known and yet to be developed communication protocols.

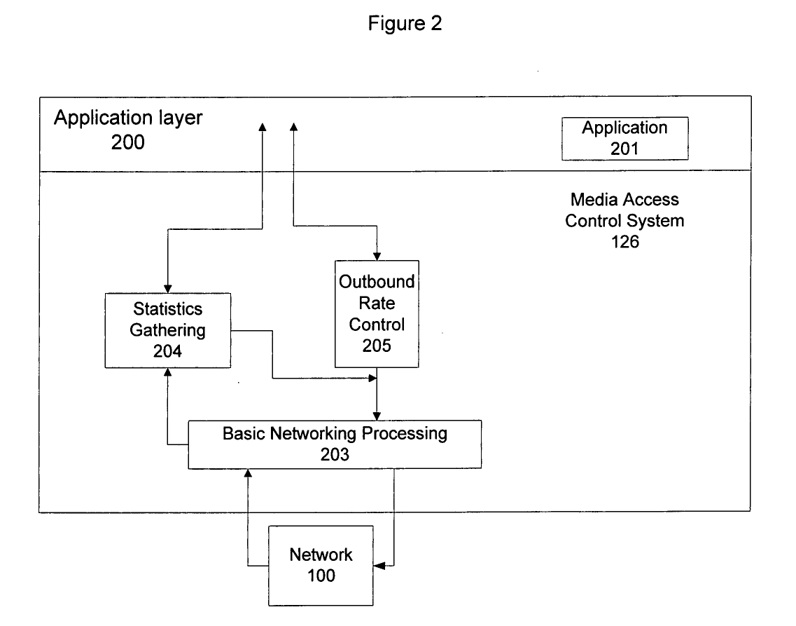

FIG. 2 depicts an exemplary media access control system consistent with the present invention. In one implementation, the exemplary media access control system 126 is replicated on each of the computers 102-104 as shown in FIG. 1. The system relies on a basic capability to send and receive data across the network 100. This capability is associated with a Basic Network Processing component (“BNP”) 203, which may provide direct access to the underlying network hardware, or access to a higher-level network protocol, e.g., User Datagram Protocol (“UDP”). An application layer 200 may also include one or more applications 201.

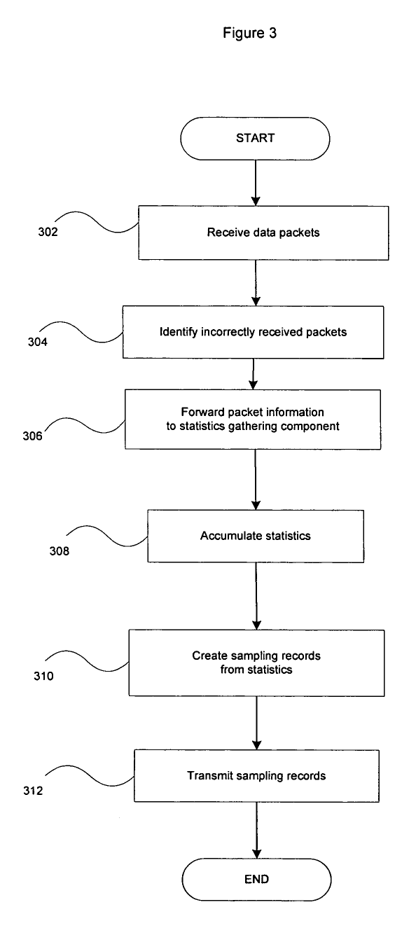

FIG. 3 depicts a flowchart representing steps in an exemplary method for receiving data packets, accumulating statistics, and transmitting sampling records in accordance with methods and systems consistent with the present invention. As the BNP 203 receives data packets from the network 100 (step 302) and identifies packets that were not correctly received (step 304), it forwards that information to a Statistics Gathering (“SG”) component 204 (step 306). The BNP 203 may identify incorrectly received packets by obtaining information from the network hardware, or it may infer such loss from higher-level protocol activity. For example, in many protocols, packet sequence numbering enables a system to deduce when packets have been missed without the need to communicate directly with the network hardware.

The SG 204 accumulates statistics continuously from information received from the BNP 203 (step 308) but divides the historical record of activity to create a series of sampling records (step 310), as discussed below, each of which may represent a constant interval of time T. Periodically, the SG 204 takes the information in its most recent complete sampling interval and transmits it directly onto the network 100 formatted in such a way that other participating computers 102-104 recognize the information as a sampling record (step 312), as discussed below. The time interval between successive transmissions of a sampling record from a given station is also described below. The SG 204 also receives this information from other computers.

In one implementation, the SG 204 tracks one or more of the following network information for each computer it has received information from (including its own computer): (1) the number of packets sent, (2) the number of packets received, (3) the number of packets dropped, (4 ) the number of messages sent, (5) the number of messages received, (6) the number of messages dropped, (7) the number of sampling records sent, (8) the number of sampling records received, (9) the number of sampling records dropped, (10) the current throttle setting and (11) whether the send is privileged. The throttle setting or value may represent the rate of transmission of data.

It should be understood, however, that there is a wide variety of additional network information that the SG 204 might use in alternative implementations. Network information may include, for example, information related to network condition, congestion or traffic. In one implementation, independent counters are kept for sampling records. For example, the SG 204 might track message sent/received/dropped counts on a per protocol basis, rather than on the global basis.

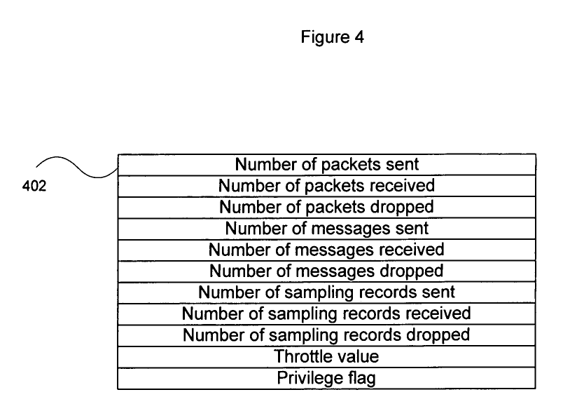

FIG. 4 depicts an exemplary sampling record 402. The nature and form of sampling records 402 may depend on the nature of the BNP 203; for example, the sampling record depicted in FIG. 4 may be based on a network layer that transmit data over the UDP protocol and uses a forward error correction scheme to achieve a higher level of reliability. The network layer includes a concept of a message, which may be a sequence of bytes (or bits) to be delivered from one computer 102 to one or more others. A message may include one or more packets. Other examples of sampling records 402 may be used.

The sampling record 402 may contain, for the reporting period, counts of packets, messages and sampling records received and dropped. In some cases, these counts may not be accurate. For example, if a given computer 102 does not receive or recognize any of the packets for a given message, then it has no knowledge of that message and thus may be unable to report it as dropped. The sampling record 402 may also contain a count of the number of packets, messages and sampling records sent by the computer 102 during the reporting period, the current setting of the computer's throttle, and a flag indicating whether the computer is a privileged sender. The flag may be an application-specific flag that may be used to allocate a disproportionate amount of bandwidth to a particular computer, e.g., the privileged sender. In one implementation, the flag is set by a computer 102 when the application has informed the network layer that it is a privileged sender. The precise meaning of being a privileged sender is another factor that can vary from implementation to implementation.

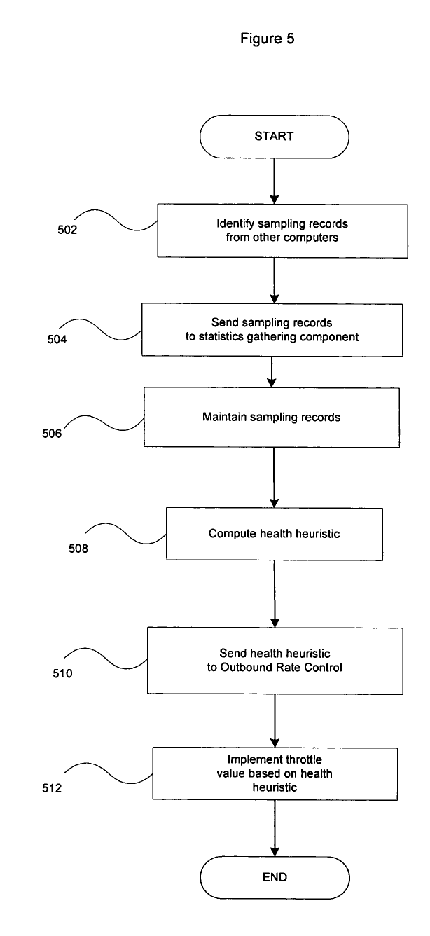

FIG. 5 depicts a flowchart illustrating steps in an exemplary method for receiving sampling records, computing a health heuristic and implementing a throttle value in accordance with methods and systems consistent with the present invention. The BNP 203 identifies sampling records 402 from other computers 102-104 (step 502) and upon their arrival forwards them to the SG 204 (step 504). In one implementation, the SG 204 maintains a history of sampling records 402 for all other participating computers 102-104 (step 506). When a new sampling record 402 arrives, it is added to the history for that particular computer. The history for a given computer may be limited in size and age, e.g., older sampling 402 records may be discarded when there is no longer room to store them, or when they have become older than a given age limit. The SG 204 may also provide access to the data contained in the sampling histories to the application layer 200 and application 201. For example, this information may be logged to disk in order to analyze traffic patterns after the fact. The application 201 could potentially display some of this information to the user, or the application may make decisions about what features to enable based on its own analysis of the data.

If the collection of histories of sampling records is referred to as H, then the SG 204 computes a health heuristic for the entire network (step 508) expressed as:
f(H, L, A)=new throttle value
where H is the set of history records maintained by the SG 204, L is a set of local network information such as the current throttle setting, and A is a set of advice from the application layer.

The advice, A, informs the health heuristic about potential near-term usage levels on the network 100. For example, if an application making use of the network is about to initiate an activity that will involve communications amongst K other computers, it may first inform the SG 204 of that fact, and then initiate the activity. This allows the health heuristic to proactively address anticipated usage of the network. In one implementation, the advice, A, is a set of numbers, one from each application, indicating the expected number of computers that will be using the network in the immediate future. It will be understood that in other implementations, the advice, A, may comprise other data, for example, the amount of data that a given application is about to send over the network.

The SG 204 also maintains a throttle minimum (Tₘᵢₙ) and throttle maximum (Tₘₐₓ) and ensures that Tₘᵢₙ [symbol] current throttle value <Tₘₐₓ. For this example, in accordance with one implementation, Tₘᵢₙ is always zero or greater and Tₘₐₓ may be infinity. Other implementations are possible.

The throttle value itself is stored in the Outbound Rate Control (“ORC”) component 205 and, in one implementation, is the minimum period of time that should elapse between each packet that is sent. Outbound network traffic (with the exception of sampling records 302) passes through the ORC 205. Thus, the ORC 205 establishes a maximum output packet rate permitted for the computer 102. Other methods of adjusting the timing of transmission of data may be used.

The health heuristic is computed periodically, with a period Tₑᵥₐₗ. Each time that the health heuristic is computed, it is passed to the ORC 205 (step 510), the ORC 205 uses that value as the current throttle value (step 512).

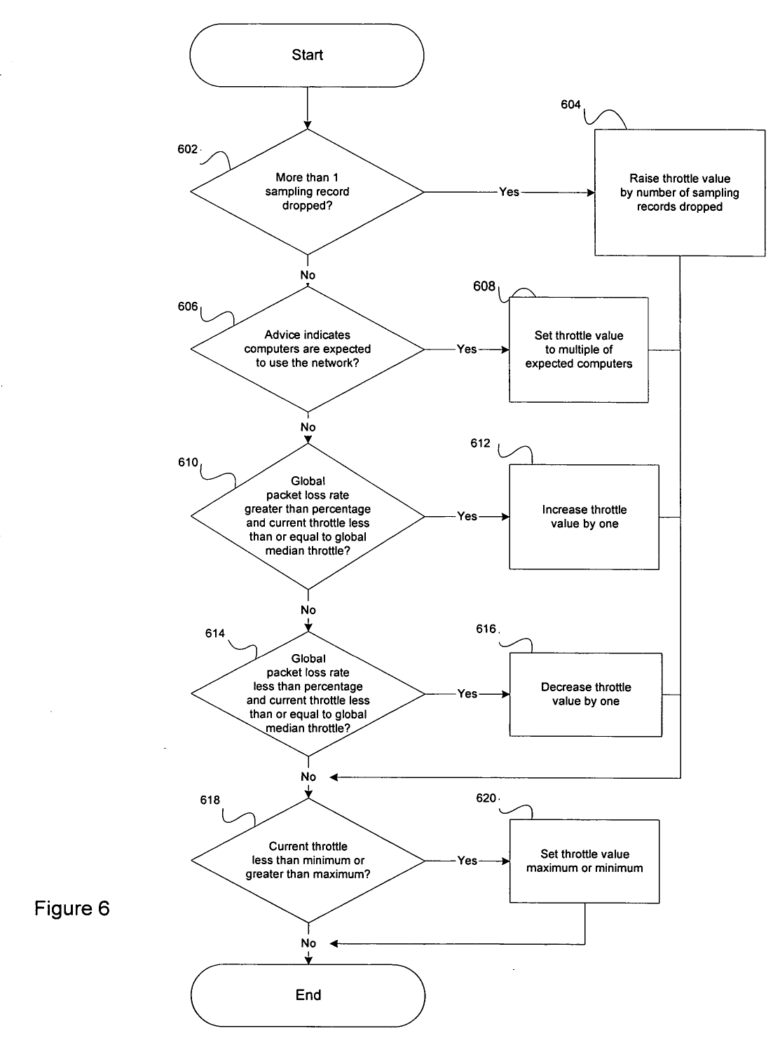

FIG. 6 illustrates steps in an exemplary method for computing a health heuristic in accordance with methods and systems consistent with the present invention. There are many ways to compute the health heuristic to compute the throttle value. In one exemplary implementation, the following steps are followed. First, if the local computer has dropped more than one sampling record in the most recent period (step 602), the throttle value is set to the current throttle value plus the number of sampling records 402 dropped (step 604), and then a maximum and minimum check is performed (step 618 described below) and the process is ended.

If the advice A indicates that a certain number of computers are expected (step 606), the throttle value is set to multiple, e.g., 10, of the number of computers expected to start using the network (step 608) and a maximum and minimum check is performed (step 618). Alternatively, if the global packet loss rate computed from the sampling records 402 is greater than a certain percentage, e.g., 6%, and the current throttle value is less than or equal to the global median throttle value (step 610), then the current throttle value is increased by one (step 612) and a maximum and minimum check is performed (step 618). If those conditions do not exist, then the system determines if the global packet loss rate computed from the sampling records 402 is less than a certain percentage, e.g., 3%, and the current throttle value is greater than or equal to the global median throttle value (step 614), and then the current throttle value is decreased by one (step 616) and a maximum and minimum check is performed (step 618). Finally, if these previous conditions do not exist, the system determines if the throttle value is greater than the maximum or less than the minimum allowed throttle value (step 618), then it is set to the maximum or the minimum (step 620), respectively.

The set of possible implementations of the health heuristic, coupled with the values for Tₘᵢₙ and Tₘₐₓ form a family of media access control protocols. It is possible that there is not an optimal element of this family. Instead, different members of the family perform more or less appropriately in various contexts. As an example, a particular member of this family that has been shown to provide improved bandwidth in wireless and wired networks is discussed below. It is understood that this particular member of the family of protocols is presented for the purpose of explanation of exemplary principles consistent with methods and systems in accordance with the invention, and does not limit the principles in accordance with methods and systems consistent with the present invention.

In one implementation, the health heuristic has a Tₘᵢₙ of 1 and a Tₘₐₓ of 500 milliseconds, except when the computer 102 is a privileged sender, in which case Tₘₐₓ is 20 milliseconds. In this examples, the health heuristic computes the new throttle setting as follows:

| | |
|---|---|
| 1. | Let the global median throttle, computed from H, be TH_{M}. |
| 2. | Let the global packet loss rate, computed from H, be PL_{G}. |
| 3. | Let the new throttle candidate be TH_{C}. |
| 4. | Let the current throttle be TH_{Now}. |
| 5. | Set TH_{C} = TH_{Now}. |
| 6. | If the local computer has dropped K₁ sampling records in the most |
| | recent sample period, where K₁ > 1, then TH_{C} = TH_{C} + K₁. Skip to |
| | minimum/maximum checks. |
| 7. | If the advice, A, indicates that N computers are about to start using |
| | the network, then TH_{C} = K₄ *N (where K₄ = 10 in one |
| | implementation). Skip to minimum/maximum checks. |
| 8. | If PL_{G} > K₂ and TH_{Now} <= TH_{M} then TH_{C} = TH_{C} + 1 (where K₂ = |
| | 6% in one implementation). |
| 9. | If PL_{G} < K₃ and TH_{Now} >= TH_{M} then TH_{C} = TH_{C} − 1 (where K₃ = |
| | 3% in one implementation). |
| 10. | If TH_{C} < T_{Min} then TH_{C} = T_{Min}. |
| 11. | If TH_{C} > T_{Max} then TH_{C} = T_{Max}. |

When good conditions are observed, e.g., due to very low packet loss, the health heuristic allows the computers to increase the rate at which packets are admitted to the network 100. When high packet loss is observed, which may be the result of collisions due to too many packets being admitted to the network 100, the health heuristic decreases the rate at which packets are admitted to the network.

In order to help control the amount of bandwidth used for exchanging sampling records 402, in one implementation, the SG 204 regulates the rate at which it sends sampling records based on the number of computers that are observed on the network 100. The goal is to ensure that, regardless of the number of computers, the number of sampling records 402 transmitted within a given interval remains fixed. As an example, assuming that the desired limit is K sampling records 402 per second, and that there are N machines participating, then on average they each may be allowed to transmit sampling packets at a rate of K/N per second. Using underlying features of the network system (in this case UDP), the computer from which each sampling record 402 was sent can be identified. The SG 204 analyzes a particular recent interval within the collection of histories of sampling records 402 and counts the number of unique sources of sampling records to determine the value used for N.

It is noted that the above elements of the above examples may be at least partially realized as software and/or hardware. Further, it is noted that a computer-readable medium may be provided having a program embodied thereon, where the program is to make a computer or system of data processing devices execute functions or operations of the features and elements of the above described examples. A computer-readable medium may include a magnetic or optical or other tangible medium on which a program is embodied, but can also be a signal, (e.g., analog or digital), electromagnetic or optical, in which the program is embodied for transmission. Further, a computer program product may be provided comprising the computer-readable medium.

The foregoing description of an implementation of in accordance with methods and systems consistent with the present invention has been presented for purposes of illustration and description. It is not exhaustive and does not limit the methods and systems in accordance with the present invention to the exemplary form disclosed. Modifications and variations are possible in light of the above teachings or may be acquired from practice. Methods and systems in accordance with the present invention may be implemented with both object-oriented and non-object-oriented programming systems.

1. A method in a data processing system for managing network communication, comprising the steps of:
setting timing of transmission of data to one or more entities on a network;
receiving network information from one or more entities on the network; and
adjusting the timing of transmission of data to the one or more entities on the network based on the received network information.

2. The method of claim 1, wherein the step of adjusting the timing of transmission of data further comprises the step of:
controlling a rate of transmission of data based on the received network information.

3. The method of claim 2, wherein the step of controlling a rate of transmission further comprises the step of:
controlling the rate of transmission of data based on local network information and network information from one or more remote entities.

4. The method of claim 2, wherein the step of controlling a rate of transmission further comprises the step of:
controlling the rate of transmission of data based on anticipated usage of the network.

5. The method of claim 1, wherein the received network information comprises network traffic information.

6. The method of claim 5, wherein the received network information comprises network error information.

7. The method of claim 1, wherein the received network information comprises a sampling record.

8. The method of claim 1, wherein receiving network information further comprises the step of:
receiving network information from all other entities on the network.

9. The method of claim 1, wherein the one or more entities are remote.

10. The method of claim 1, wherein the one or more entities comprise computers.

11. The method of claim 1, wherein the network comprises a wireless network.

12. The method of claim 1, wherein the network comprises a wired network.

13. The method of claim 1, wherein the network comprises a broadcast network.

14. The method of claim 1, further comprising the steps of:
monitoring network condition on the one or more entities on the network; and
transmitting the network information from the one or more entities based on the monitoring.

15. The method of claim 14, wherein the monitoring further comprises:
receiving data from the network; and
analyzing the received data to monitor network condition.

16. A method in a data processing system, comprising the steps of:
monitoring local network information on an entity on a network; and
transmitting the monitored local network information to one or more remote entities on the network so that the one or more remote entities can adjust timing of transmission of data based on the transmitted local network information.

17. The method of claim 16, further comprising the steps of:
receiving the local network information on the one or more remote entities; and
adjusting the timing of transmission of data from the one or remote entities based on the received local network information.

18. The method of claim 16, wherein the network comprises a wireless network.

19. The method of claim 16, wherein the network comprises a wired network.

20. The method of claim 16, wherein the network comprises a broadcast network.

21. A data processing system, comprising:
a memory having a program that sets timing of transmission of data to one or more entities on a network, receives network information from one or more entities on the network, and adjusts the timing of transmission of data to the one or more entities on the network based on the received network information; and
a processor for running the program.

22. The data processing system of claim 21, wherein the program further controls a rate of transmission of data based on the received network information.

23. The data processing system of claim 22, wherein the program further controls the rate of transmission of data based on local network information and network information from one or more remote entities.

24. The data processing system of claim 22, wherein the program further controls the rate of transmission of data based on anticipated usage of the network.

25. The data processing system of claim 21, wherein the received network information comprises network traffic information.

26. The data processing system of claim 25, wherein the received network information comprises network error information.

27. The data processing system of claim 21, wherein the received network information comprises a sampling record.

28. The data processing system of claim 21, wherein the program further receives network information from all other entities on the network.

29. The data processing system of claim 21, wherein the one or more entities are remote.

30. The data processing system of claim 21, wherein the one or more entities comprise computers.

31. The data processing system of claim 21, wherein the network comprises a wireless network.

32. The data processing system of claim 21, wherein the network comprises a wired network.

33. The data processing system of claim 21, wherein the network comprises a broadcast network.

34. The data processing system of claim 21, wherein the program further monitors network condition on the one or more entities on the network, and transmits the network information from the one or more entities based on the monitoring.

35. The data processing system of claim 34, wherein the program further receives data from the network, and analyzes the received data to monitor network condition.

36. A data processing system, comprising:
a memory having a program that monitors local network information on an entity on a network, and transmits the monitored local network information to one or more remote entities on the network so that the one or more remote entities can adjust timing of transmission of data based on the transmitted local network information; and
a processor for running the program.

37. The data processing system of claim 36, wherein a second program further receives the local network information on the one or more remote entities, and adjusts the timing of transmission of data from the one or remote entities based on the received local network information.

38. The data processing system of claim 36, wherein the network comprises a wireless network.

39. The data processing system of claim 36, wherein the network comprises a wired network.

40. The data processing system of claim 36, wherein the network comprises a broadcast network.

41. A computer-readable medium containing instructions for controlling a data processing system to perform a method for managing network communication, the method comprising the steps of:
setting timing of transmission of data to one or more entities on a network;
receiving network information from one or more entities on the network; and
adjusting the timing of transmission of data to the one or more entities on the network based on the received network information.

42. The computer-readable medium of claim 41, wherein the step of adjusting the timing of transmission of data further comprises the step of:
controlling a rate of transmission of data based on the received network information.

43. The computer-readable medium of claim 42, wherein the step of controlling a rate of transmission further comprises the step of:
controlling the rate of transmission of data based on local network information and network information from one or more remote entities.

44. The computer-readable medium of claim 42, wherein the step of controlling a rate of transmission further comprises the step of:
controlling the rate of transmission of data based on anticipated usage of the network.

45. The computer-readable medium of 41, wherein the received network information comprises network traffic information.

46. The computer-readable medium of claim 45, wherein the received network information comprises network error information.

47. The computer-readable medium of claim 41, wherein the received network information comprises a sampling record.

48. The computer-readable medium of claim 41, wherein receiving network information further comprises the step of:
receiving network information from all other entities on the network.

49. The computer-readable medium of claim 41, wherein the one or more entities are remote.

50. The computer-readable medium of claim 41, wherein the one or more entities comprise computers.

51. The computer-readable medium of claim 41, wherein the network comprises a wireless network.

52. The computer-readable medium of claim 41, wherein the network comprises a wired network.

53. The computer-readable medium of claim 41, wherein the network comprises a broadcast network.

54. The computer-readable medium of claim 41, wherein the method further comprises the steps of:
monitoring network condition on the one or more entities on the network; and
transmitting the network information from the one or more entities based on the monitoring.

55. The computer-readable medium of claim 54, wherein the monitoring further comprises:
receiving data from the network; and
analyzing the received data to monitor network condition.

56. A computer-readable medium containing instructions for controlling a data processing system to perform a method comprising the steps of:
monitoring local network information on an entity on a network; and
transmitting the monitored local network information to one or more remote entities on the network so that the one or more remote entities can adjust timing of transmission of data based on the transmitted local network information.

57. The computer-readable medium of claim 56, wherein the method further comprises the steps of:
receiving the local network information on the one or more remote entities; and
adjusting the timing of transmission of data from the one or remote entities based on the received local network information.

58. The computer-readable medium of claim 56, wherein the network comprises a wireless network.

59. The computer-readable medium of claim 56, wherein the network comprises a wired network.

60. The computer-readable medium of claim 56, wherein the network comprises a broadcast network.

61. A data processing system, comprising:
means for setting timing of transmission of data to one or more entities on a network;
means for receiving network information from one or more entities on the network; and
means for adjusting the timing of transmission of data to the one or more entities on the network based on the received network information.
